(19) United States
(12) Patent Application Publication
(10) Pub. No.: US 2024/0240706 A1
(43) Pub. Date: Jul. 18, 2024

(54) Fastening Apparatus and Gearbox

(71) Applicant: Nanjing High-speed Gear Manufacturing Co., Ltd., Jiangsu (CN)

(72) Inventors: Haifeng LUO, Jiangsu (CN); Yongqiang XIONG, Jiangsu (CN); Wenxiang DING, Jiangsu (CN); Zhongkui SUN, Jiangsu (CN); Hongjian LI, Jiangsu (CN); Hechao ZHANG, Jiangsu (CN)

(21) Appl. No.: 18/395,875

(22) Filed: Dec. 26, 2023

(30) Foreign Application Priority Data
Jan. 13, 2023 (CN) 202310040728.6

(51) Int. Cl. F16H 57/02; F16B 43/00; F16C 17/02

(52) U.S. Cl. CPC F16H 57/02; F16B 43/00; F16C 17/02; F16C 2361/65

(57) ABSTRACT

A fastening apparatus for connecting a thrust pad to a carrying member. The thrust pad is provided with a first recess and a communication hole communicating with the first recess. The carrying member is provided with a threaded hole. The aperture of the communication hole is greater than the aperture of the threaded hole. The fastening apparatus includes a bolt and a connection structure. An end cap of the bolt is disposed in the first recess. A screw of the bolt passes through the connection structure and is threaded into the threaded hole. The connection structure is able to be clamped between the end cap and the carrying member.

### CROSS-REFERENCE TO RELATED APPLICATION(S)

This application claims priority to Chinese Patent Application No. 202310040728.6 filed Jan. 13, 2023, the disclosure of which is incorporated herein by reference in its entirety.

### TECHNICAL FIELD

The present disclosure relates to the field of gearbox technology and, in particular, to a fastening apparatus of a thrust pad and a gearbox.

### BACKGROUND

A thrust pad is designed to guarantee the formation of an axial gap between static and dynamic components without direct contact, to reduce surface abrasion, and to prolong service life. In a wind power sliding bearing gearbox, a planet-gear axial thrust pad is usually mounted between a planet gear and a planet carrier. The thrust pad is secured on the planet carrier through a bolt.

During the operation process of the wind power gearbox, temperatures of components inside the gearbox, such as the planet gear, a rotating stand, and the thrust pad, fluctuate greatly. At an ambient temperature of 20° C., the thrust pad is pre-tightened through the bolt. During operation, the internal temperature of the gearbox rises. Because the coefficient of thermal expansion of the material of the thrust pad is greater than the coefficient of thermal expansion of the material of the bolt, the thrust pad expands in the radial direction. The connection stiffness between the thrust pad and the bolt decreases. The pre-tightening force of the bolt decreases. The expansion of the thrust pad in the axial direction and the clamping force of the bolt lead to the plastic deformation of the thrust pad. When the internal temperature of the gearbox decreases again, the thrust pad cannot rebound to its original size in the axial direction, and the pre-tightening force of the bolt also decreases.

Under the alternate fluctuation of temperature rise and fall, the pre-tightening force of the bolt decreases by 20% to 30%. After a period of use, the planet-gear thrust pad is no longer firmly attached to the planet carrier, thereby resulting in the failure of the gearbox.

### SUMMARY

The present disclosure provides a fastening apparatus of a thrust pad and a gearbox. In the case where the thrust pad has little to no plastic deformation, it guarantees that the tightening torque of a bolt that can be born by the thrust pad is increased and that the pre-tightening force of the bolt is compensated for. Therefore, a shortcoming that the mounting of the bolt is easy to loosen is overcome. The thrust pad is fully secured on a carrying member, avoiding the failure of the gearbox.

The present disclosure adopts the technical solutions below.

In one aspect, a fastening apparatus of a thrust pad is provided. The fastening apparatus is configured to connect a thrust pad to a carrying member. The thrust pad is provided with a first recess and a communication hole communicating with the first recess. The carrying member is provided with a threaded hole. An aperture of the communication hole is greater than an aperture of the threaded hole. The fastening apparatus includes a bolt and a connection structure. An end cap of the bolt is disposed in the first recess. A screw of the bolt passes through the connection structure and is threaded into the threaded hole. The connection structure is able to be clamped between the end cap and the carrying member.

In some possible embodiments, the connection structure includes a flange pad and a bushing body that are connected to each other. The flange pad is disposed in the first recess. The bushing body is disposed in the communication hole. The flange pad is clamped between the end cap and a bottom of the first recess. A reserved gap is formed between the bushing body and the carrying member.

In some possible embodiments, the flange pad and the bushing body are integrally structured, or the flange pad and the bushing body are separably structured.

In some possible embodiments, the connection structure includes a flange pad and a bushing body. The flange pad is disposed in the first recess. The bushing body is disposed in the communication hole. The flange pad is clamped between the end cap and a bottom of the first recess. One end of the bushing body abuts against the carrying member. A reserved gap is formed between another end of the bushing body and the flange pad.

In some possible embodiments, the thrust pad further includes a second recess. The first recess and the second recess communicate with two sides of the communication hole respectively. An area of a bottom of the first recess and an area of a bottom of the second recess are each greater than an opening area of the communication hole. An opening of the second recess faces the carrying member.

In some possible embodiments, the connection structure includes a flange pad and a bushing body. The flange pad is disposed in the first recess. The bushing body is disposed in the communication hole. The flange pad is clamped between the end cap and the bottom of the first recess. A reserved gap is formed between the bushing body and one of the flange pad or the carrying member.

In some possible embodiments, the connection structure and the bolt are integrally structured. The connection structure is connected to an end of the end cap facing the screw. The end cap abuts against a bottom of the first recess. The connection structure is disposed in the communication hole. A reserved gap is formed between the carrying member and an end of the connection structure facing away from the end cap.

In some possible embodiments, the connection structure includes a bushing body. The bushing body passes through the communication hole. The screw passes through the bushing body. Two ends of the bushing body abut against the end cap and the carrying member respectively. A reserved gap is formed between the end cap and a bottom of the first recess.

In some possible embodiments, the connection structure includes a bushing body. The bushing body passes through the communication hole. The screw passes through the bushing body. One end of the bushing body abuts against the carrying member. The end cap abuts against a bottom of the first recess. A reserved gap is formed between another end of the bushing body and the end cap.

In some possible embodiments, a size of the reserved gap is greater than or equal to 0.

In another aspect, a gearbox is provided. The gearbox includes a thrust pad, a carrying member, and the preceding fastening apparatus of a thrust pad. The fastening apparatus of a thrust pad is configured to connect the thrust pad to the carrying member.

### BRIEF DESCRIPTION OF DRAWINGS

FIG. 1 is a schematic showing a partial structure of a gearbox according to embodiment one of the present disclosure.

FIG. 2 is a schematic showing a fastening apparatus of a thrust pad according to embodiment one of the present disclosure.

FIG. 3 is a schematic showing a fastening apparatus of a thrust pad according to embodiment two of the present disclosure.

FIG. 4 is a schematic showing a fastening apparatus of a thrust pad according to embodiment three of the present disclosure.

FIG. 5 is a schematic showing a fastening apparatus of a thrust pad according to embodiment four of the present disclosure.

FIG. 6 is a schematic showing a fastening apparatus of a thrust pad according to embodiment five of the present disclosure.

FIG. 7 is a schematic showing a fastening apparatus of a thrust pad according to embodiment six of the present disclosure.

FIG. 8 is a schematic showing a fastening apparatus of a thrust pad according to embodiment seven of the present disclosure.

### REFERENCE LIST

100 thrust pad
101 first recess
102 communication hole
103 second recess
104 annular cantilever structure
200 carrying member
201 threaded hole
300 fastening apparatus
1 bolt
11 end cap
12 screw
13 shoulder
2 flange pad
3 bushing body
A reserved gap

### DETAILED DESCRIPTION

The technical solutions in embodiments of the present disclosure are further described in detail hereinafter in conjunction with the drawings. Apparently, the embodiments described below are part, not all, of embodiments of the present disclosure.

In the description of the present disclosure, unless otherwise expressly specified and limited, the term “connected to each other”, “connected” or “secured” is to be construed in a broad sense, for example, as securely connected, detachably connected or integrated; mechanically connected or electrically connected; directly connected to each other or indirectly connected to each other via an intermediary; or internal connection between two components or interaction relations between two components. For those of ordinary skill in the art, specific meanings of the preceding terms in the present disclosure may be construed based on specific situations.

In the present disclosure, unless otherwise expressly specified and limited, when a first feature is described as “above” or “below” a second feature, the first feature and the second feature may be in direct contact or be in contact via another feature between the two features. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

### Embodiment One

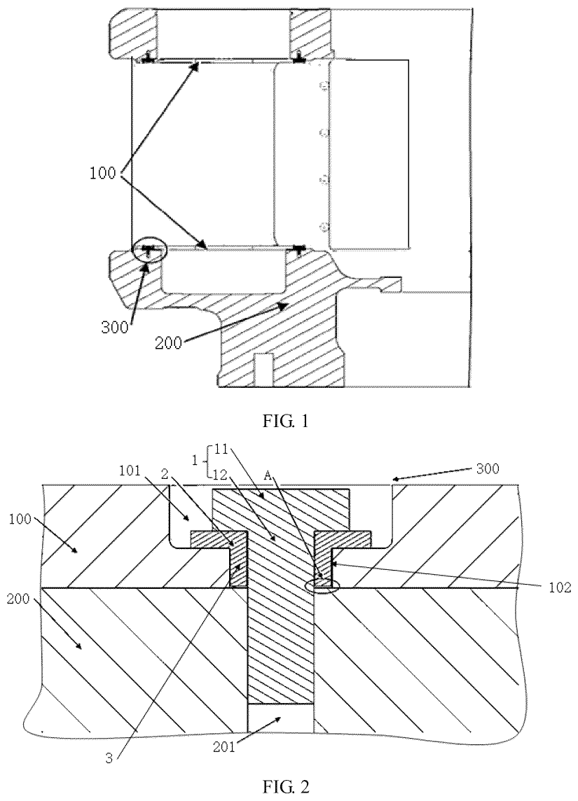

This embodiment provides a gearbox. As shown in FIG. 1, the gearbox includes a thrust pad 100, a carrying member 200, and a fastening apparatus of a thrust pad. The fastening apparatus 300 of a thrust pad is configured to connect the thrust pad 100 to the carrying member 200. The carrying member 200 may be a rotating stand. The carrying member 200 may be set according to needs and is not limited. This embodiment provides a fastening apparatus of a thrust pad. As shown in FIGS. 1 and 2, the thrust pad 100 is provided with a first recess 101 and a communication hole 102 communicating with the first recess 101. The carrying member 200 is provided with a threaded hole 201. The aperture of the communication hole 102 is greater than the aperture of the threaded hole 201. The fastening apparatus 300 includes a bolt 1 and a connection structure. An end cap 11 of the bolt 1 is disposed in the first recess 101. A screw 12 of the bolt 1 passes through the connection structure and is threaded into the threaded hole 201. The connection structure is able to be clamped between the end cap 11 and the carrying member 200.

The carrying member 200 is provided with the threaded hole 201 to be connected to the bolt 1 in a threaded manner so as to mount and carry the thrust pad 100. The bolt 1 presses and secures the thrust pad 100 on the carrying member 200 through the connection structure. The connection structure is used for bearing the tightening torque of the bolt 1 directly, preventing the thrust pad 100 from directly bearing the full tightening torque of the bolt 1. Therefore, it guarantees that the thrust pad 100 has little to no plastic deformation, preventing the thrust pad 100 from being crushed, improving the tightening torque of the bolt 1 that can be born by the thrust pad 100, and compensating for the pre-tightening force loss of the bolt 1. The arrangement of the connection structure increases the function area of the bolt 1. Therefore, a greater pre-tightening force of the bolt 1 can be applied, thereby enabling various components that are connected to each other to be sufficiently stable and firm without looseness, overcoming the shortcoming that the existing mounting of the bolt 1 is easy to loosen. The thrust pad 100 is fully secured on the carrying member 200, avoiding the failure of the gearbox.

The carrying member 200 may be a planet carrier or a gear. The thrust pad 100 is disposed between the planet carrier and the gear. The thrust pad 100 is connected to one of the planet carrier or the gear through the fastening apparatus of a thrust pad.

In an embodiment, the coefficient of thermal expansion of the thrust pad 100 may be the same as, greater than, or less than the coefficient of thermal expansion of the material of the bolt 1. The material of the thrust pad 100 is not limited, improving the applicability of the fastening apparatus 300.

In an embodiment, the connection structure is disposed between the thrust pad 100 and the bolt 1. The thrust pad 100 is in indirect contact with the bolt 1 through the connection structure.

In an embodiment, as shown in FIG. 2, the connection structure includes a flange pad 2 and a bushing body 3 that are connected to each other. The flange pad 2 is disposed in the first recess 101. The bushing body 3 is disposed in the communication hole 102. The flange pad 2 is clamped between the end cap 11 and the bottom of the first recess 101. A reserved gap A is formed between the bushing body 3 and the carrying member 200. The bolt 1 applies a force to the bushing. After the bolt 1 is tightened, the reserved gap A is eliminated. A lower end face of the bushing is in contact with the carrying member 200 to press the thrust pad 100 and secure the thrust pad 100 on the carrying member 200. In design, the size tolerance of the bushing body 3 is controlled. In an original state, the lower end face of the bushing body 3 and a surface of the carrying member 200 form the gap, that is, the reserved gap A. The size of the reserved gap A is greater than or equal to 0. The size of the reserved gap A is related to the magnitude of the tightening torque of the bolt 1 and is optionally determined by calculation to guarantee sufficient stable connection. The tightening torque of the bolt 1 is designated by adjusting the size of the reserved gap A, guaranteeing a sufficient clamping force and no looseness. Moreover, the bushing body 3 is supported between the bolt 1 and the carrying member 200. The thrust pad 100 is not in direct contact with the bolt 1 so that the thrust pad 100 has little to no plastic deformation, preventing the thrust pad 100 from being crushed. Additionally, the bolt 1 acts directly on the flange pad 2 and the bushing body 3 to be connected to the carrying member 200. The contact area between the flange pad 2 and the thrust pad 100 is relatively increased. Therefore, a greater pre-tightening force of the bolt 1 can be applied, guaranteeing that various components are connected stably without looseness.

Optionally, the flange pad 2 and the bushing body 3 are each provided with a through hole to facilitate the passage of the screw 12. The first recess 101 is a circular recess. The outer diameter of the flange pad 2 is less than the inner diameter of the first recess 101 so that the flange pad 2 is accommodated in the first recess 101.

In an embodiment, the flange pad 2 and the bushing body 3 are integrally structured. For example, a flange bushing may be purchased, which is convenient and reliable. In other embodiments, the flange pad 2 and the bushing body 3 are separably structured. The flange pad 2 and the bushing body 3 may be connected through, for example, bonding, welding or fastener connection. The connection may be set according to needs and is not limited.

### Embodiment Two

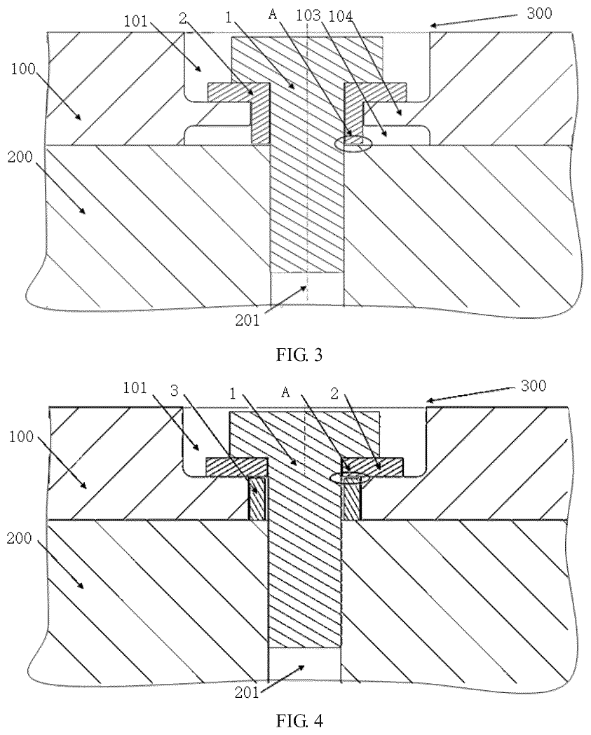

This embodiment provides a fastening apparatus of a thrust pad. The fastening apparatus in this embodiment is the basically same as the structure in embodiment one, with no repetition of identical parts. A difference between this embodiment and the preceding embodiment lies in that, as shown in FIG. 3, the thrust pad 100 further includes a second recess 103. The first recess 101 and the second recess 103 communicate with two sides of the communication hole 102 respectively. The area of the bottom of the first recess 101 and the area of the bottom of the second recess 103 are each greater than the opening area of the communication hole 102. An opening of the second recess 103 faces the carrying member 200. The connection structure includes a flange pad 2 and a bushing body 3. The flange pad 2 is disposed in the first recess 101. The bushing body 3 is disposed in the communication hole 102. The flange pad 2 is clamped between the end cap 11 and the bottom of the first recess 101. A reserved gap A is formed between the carrying member 200 and the bushing body 3.

On the basis of embodiment one, the structure of the thrust pad 100 is modified. The first recess 101 and the second recess 103 form an annular cantilever structure 104 with a certain thickness at the periphery of the communication hole 102. The thrust pad 100 forms a structure having an elastic rebound and may maintain the elastic deformation with a first amplitude. When temperatures fluctuate, the thrust pad 100 has enough elasticity and stability, further improving the firmness of securing the thrust pad 100 on the carrying member 200.

### Embodiment Three

This embodiment provides a fastening apparatus of a thrust pad. The fastening apparatus in this embodiment is the basically same as the structure in embodiment one. The same part is not repeated. A difference between this embodiment and the preceding embodiment lies in that, as shown in FIG. 4, the connection structure includes a flange pad 2 and a bushing body 3. The flange pad 2 is disposed in the first recess 101. The bushing body 3 is disposed in the communication hole 102. The flange pad 2 is clamped between the end cap 11 and the bottom of the first recess 101. One end of the bushing body 3 abuts against the carrying member 200. A reserved gap A is formed between the other end of the bushing body 3 and the flange pad 2.

Optionally, the flange pad 2 may be a metal pad with a certain thickness. An upper surface of the metal pad and a lower surface of the metal pad are in contact with the end cap 11 of the bolt 1 and the thrust pad 100 respectively. The lower surface of the pad 2 and an upper surface of the bushing form the gap. The bolt 1 is not in direct contact with the thrust pad 100 and the bushing body 3 and acts directly on the pad 2. After the gap is consumed, the lower surface of the pad 2 is in contact with the bushing body 3 and presses the thrust pad 100. The existence of the pad 2 may get a greater pre-tightening force of the bolt 1 to be born, guaranteeing that various components are connected stably without looseness. Moreover, the bushing body 3 is supported between the pad 1 and the carrying member 200, preventing the thrust pad 100 from being crushed.

### Embodiment Four

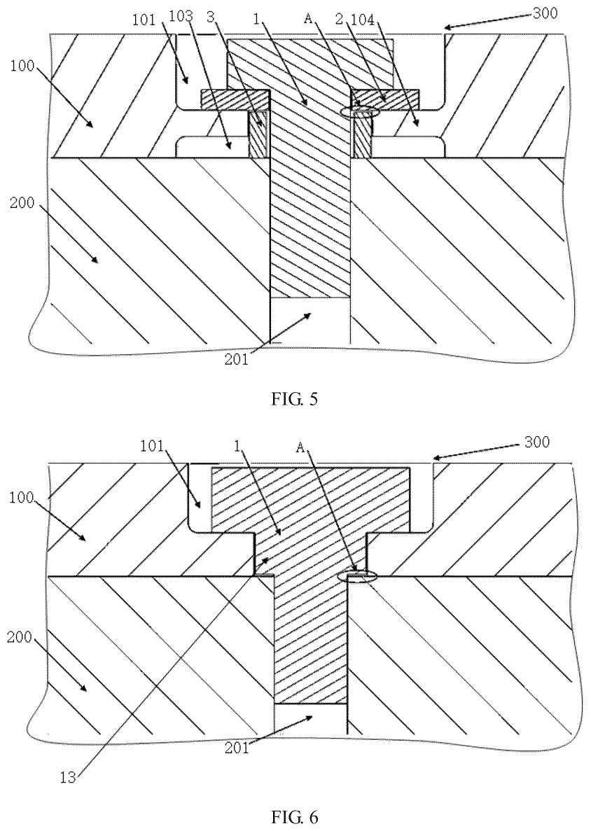

This embodiment provides a fastening apparatus of a thrust pad. The fastening apparatus in this embodiment is the basically same as the structure in embodiment one. The same part is not repeated. A difference between this embodiment and the preceding embodiments lies in that, as shown in FIG. 5, the thrust pad 100 further includes a second recess 103. The first recess 101 and the second recess 103 communicate with two sides of the communication hole 102 respectively. The area of the bottom of the first recess 101 and the area of the bottom of the second recess 103 are each greater than the opening area of the communication hole 102. An opening of the second recess 103 faces the carrying member 200. The connection structure includes a flange pad 2 and a bushing body 3. The flange pad 2 is disposed in the first recess 101. The bushing body 3 is disposed in the communication hole 102. The flange pad 2 is clamped between the end cap 11 and the bottom of the first recess 101. A reserved gap A is formed between the flange pad 2 and the bushing body 3.

On the basis of embodiment three, the structure of the thrust pad 100 is modified. The first recess 101 and the second recess 103 form an annular cantilever structure 104 with a certain thickness at the periphery of the communication hole 102. The thrust pad 100 forms a structure having an elastic rebound and may maintain the elastic deformation with a certain amplitude. When temperature fluctuates, the thrust pad 100 has enough elasticity and stability, further improving the firmness of securing the thrust pad 100 on the carrying member 200.

### Embodiment Five

This embodiment provides a fastening apparatus of a thrust pad. The fastening apparatus in this embodiment is the basically same as the structure in embodiment one. The same part is not repeated. A difference between this embodiment and the preceding embodiments lies in that, as shown in FIG. 6, the connection structure and the bolt 1 are integrally structured. The connection structure is connected to an end of the end cap 11 facing the screw 12. The end cap 11 abuts against the bottom of the first recess 101. The connection structure is disposed in the communication hole 102. A reserved gap A is formed between the carrying member 200 and an end of the connection structure facing away from the end cap 11.

The connection structure and the bolt 1 are integrated to form a non-standard bolt 1. The end cap 11 of the bolt 1 is in direct contact with the thrust pad 100. The connection structure is located between the screw 12 and the end cap 11 to form a shoulder 13 with a plane. An end face of the shoulder 13 and a surface of the carrying member 200 form the reserved gap A. The bolt 1 is tightened. After the gap is consumed, the end face of the shoulder 13 is in contact with the carrying member 200 and presses the thrust pad 100. The shoulder 13 is supported on the surface of the carrying member 200, increasing the contact area between the bolt 1 and the carrying member 200 and thrust pad 100, bearing a greater pre-tightening force of the bolt 1, guaranteeing that various components are connected stably without looseness, and preventing the thrust pad 100 from being crushed.

### Embodiment Six

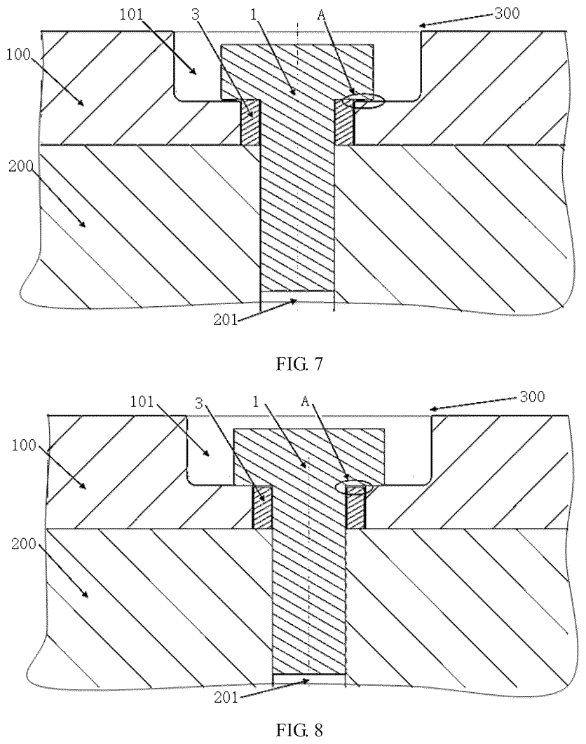

This embodiment provides a fastening apparatus of a thrust pad. The fastening apparatus in this embodiment is the basically same as the structure in embodiment one. The same part is not repeated. A difference between this embodiment and the preceding embodiment lies in that, as shown in FIG. 7, the connection structure includes a bushing body 3. The bushing body 3 passes through the communication hole 102. The screw 12 passes through the bushing body 3. Two ends of the bushing body 3 abut against the end cap 11 and the carrying member 200 respectively. A reserved gap A is formed between the end cap 11 and the bottom of the first recess 101.

An upper surface of the bushing body 3 and a lower surface of the bushing body 3 are in contact with the end cap 11 of the bolt 1 and the carrying member 200 respectively. The height of the bushing body 3 is greater than the depth of the communication hole 102 so that the reserved gap A is formed between a lower end face of the end cap 11 of the bolt 1 and the bottom of the first recess 101 of the thrust pad 100. The bolt 1 is not in direct contact with the thrust pad 100 and acts directly on the bushing body 3. After the gap is consumed, a lower end surface of the bolt 1 is in contact with the thrust pad 100, pressing the thrust pad 100. The tightening torque of the bolt 1 is designated by adjusting the size of the gap, guaranteeing that various components are connected stably without looseness. Moreover, the bushing body 3 is supported between the end cap 11 of the bolt 1 and the carrying member 200 so as to carry part of the tightening torque of the bolt 1, preventing the thrust pad 100 from being crushed.

### Embodiment Seven

This embodiment provides a fastening apparatus of a thrust pad. The fastening apparatus in this embodiment is the basically same as the structure in embodiment one with no repetition of identical parts. A difference between this embodiment and the preceding embodiments lies in that, as shown in FIG. 8, the connection structure includes a bushing body 3. The bushing body 3 passes through the communication hole 102. The screw 12 passes through the bushing body 3. One end of the bushing body 3 abuts against the carrying member 200. The end cap 11 abuts against the bottom of the first recess 101. A reserved gap A is formed between the other end of the bushing body 3 and the end cap 11.

The height of the bushing body 3 is less than the depth of the communication hole 102 so that a lower end face of the end cap 11 of the bolt 1 and an upper surface of the bushing body 3 form the gap. In an original state, the bolt 1 is in direct contact with the thrust pad 100. The bolt 1 is tightened. After the thrust pad 100 is deformed and the gap is consumed, the lower end face of the end cap 11 of the bolt 1 is in contact with the bushing, pressing the thrust pad 100. The tightening torque of the bolt 1 is designated by adjusting the size of the gap, guaranteeing that various components are connected stably without looseness. Moreover, the bushing body 3 is supported between the end cap 11 of the bolt 1 and the carrying member 200 so as to carry part of the tightening torque of the bolt 1, preventing the thrust pad 100 from being crushed.

For the fastening apparatus of a thrust pad and the gearbox provided in the present disclosure, the carrying member is provided with the threaded hole to be connected to the bolt in a threaded manner so as to mount and carry the thrust pad. The bolt presses and secures the thrust pad on the carrying member through the connection structure. The connection structure is used for bearing the tightening torque of the bolt directly, preventing the thrust pad from directly bearing the full tightening torque of the bolt. Therefore, it guarantees that the thrust pad has little to no plastic deformation, preventing the thrust pad from being crushed, improving the tightening torque of the bolt that can be born by the thrust pad, and compensating for the pre-tightening force of the bolt. The arrangement of the connection structure increases the function area of the bolt. Therefore, a greater pre-tightening force of the bolt can be applied, thereby enabling various components that are connected to each other to be sufficiently stable and firm without looseness, overcoming the shortcoming that the existing mounting of the bolt is easy to loosen. The thrust pad is fully secured on the carrying member, avoiding the failure of the gearbox.

What is claimed is:

1. A fastening apparatus, for connecting a thrust pad to a carrying member, wherein the thrust pad is provided with a first recess and a communication hole communicating with the first recess, the carrying member is provided with a threaded hole, an aperture of the communication hole is greater than an aperture of the threaded hole, the fastening apparatus comprises a bolt and a connection structure, an end cap of the bolt is disposed in the first recess, a screw of the bolt passes through the connection structure and is threaded into the threaded hole, and the connection structure is able to be clamped between the end cap and the carrying member.

2. The fastening apparatus according to claim 1, wherein the thrust pad is provided with a protruded portion, a lower surface of the protruded portion and an upper surface of the carrying member are in contact, the communication hole is formed in the protruded portion, a gap is formed between a lower surface of the connection structure and the upper surface of the carrying member, and is configured to allow deformation of the connection structure caused by the screw.

3. The fastening apparatus according to claim 1, further comprising a bushing body, the bushing body is disposed in the communication hole, an end cap of the bolt is disposed in the first recess, a screw of the bolt passes through the bushing body and is threaded into the threaded hole, and a reserved gap is formed between the bushing body and a bottom of the first recess or between the bushing body and the carrying member.

4. The fastening apparatus according to claim 3, wherein a flange pad is disposed in the first recess, the flange pad is clamped between the end cap and the bottom of the first recess, the reserved gap is formed between a lower end of the flange pad and an upper end of the bushing body or between the bushing body and the carrying member.

5. The fastening apparatus according to claim 1, wherein the connection structure comprises a flange pad and a bushing body that are connected to each other, the flange pad is disposed in the first recess, the bushing body is disposed in the communication hole, the flange pad is clamped between the end cap and a bottom of the first recess, and a reserved gap is formed between the bushing body and the carrying member.

6. The fastening apparatus according to claim 5, wherein the flange pad and the bushing body are integrally structured, or the flange pad and the bushing body are separably structured.

7. The fastening apparatus according to claim 1, wherein the connection structure comprises a flange pad and a bushing body, the flange pad is disposed in the first recess, the bushing body is disposed in the communication hole, the flange pad is clamped between the end cap and a bottom of the first recess, one end of the bushing body abuts against the carrying member, and a reserved gap is formed between another end of the bushing body and the flange pad.

8. The fastening apparatus according to claim 1, wherein the thrust pad further comprises a second recess, the first recess and the second recess communicate with two sides of the communication hole respectively, an area of a bottom of the first recess and an area of a bottom of the second recess are each greater than an opening area of the communication hole, and an opening of the second recess faces the carrying member; and
the connection structure comprises a flange pad and a bushing body, the flange pad is disposed in the first recess, the bushing body is disposed in the communication hole, the flange pad is clamped between the end cap and the bottom of the first recess, and a reserved gap is formed between the bushing body and one of the carrying member or the flange pad.

9. The fastening apparatus according to claim 1, wherein the connection structure and the bolt are integrally structured, the connection structure is connected to an end of the end cap facing the screw, the end cap abuts against a bottom of the first recess, the connection structure is disposed in the communication hole, and a reserved gap is formed between the carrying member and an end of the connection structure facing away from the end cap.

10. The fastening apparatus according to claim 1, wherein the connection structure comprises a bushing body, the bushing body passes through the communication hole, the screw passes through the bushing body, two ends of the bushing body abut against the end cap and the carrying member respectively, and a reserved gap is formed between the end cap and a bottom of the first recess.

11. The fastening apparatus according to claim 1, wherein the connection structure comprises a bushing body, the bushing body passes through the communication hole, the screw passes through the bushing body, one end of the bushing body abuts against the carrying member, the end cap abuts against a bottom of the first recess, and a reserved gap is formed between another end of the bushing body and the end cap.

12. The fastening apparatus according to claim 3, wherein a size of the reserved gap is greater than or equal to 0.

13. A fastening apparatus, for connecting a thrust pad to a carrying member, wherein the thrust pad is provided with a first recess and a communication hole communicating with the first recess, the carrying member is provided with a threaded hole, an aperture of the communication hole is greater than an aperture of the threaded hole, the fastening apparatus comprises a bolt and a flange pad, the thrust pad is also provided with a protruded portion, the communication hole is formed in the protruded portion, a lower surface of the protruded portion and an upper surface of the carrying member are in contact, an end cap of the bolt is disposed in the first recess, a screw of the bolt passes through the flange pad and is threaded into the threaded hole, and the flange pad is clamped between the end cap and a bottom of the first recess.

14. The fastening apparatus according to claim 13, wherein a bushing body is disposed in the communication hole, and the bushing body is capable of abutting against the carrying member.

15. The fastening apparatus according to claim 14, wherein the flange pad and the bushing body are integrally structured, and a reserved gap is formed between the lower end of the flange pad and an upper end of the bushing body: or
wherein the flange pad and the bushing body are separably structured, and a reserved gap is formed between the lower end and the carrying member.

16. A gearbox, comprising a thrust pad, a carrying member, and the fastening apparatus according to claim 1, wherein the fastening apparatus is configured to connect the thrust pad to the carrying member.

17. The gearbox according to claim 16, wherein the connection structure comprises a flange pad and a bushing body that are connected to each other, the flange pad is disposed in the first recess, the bushing body is disposed in the communication hole, the flange pad is clamped between the end cap and a bottom of the first recess, and a reserved gap is formed between the bushing body and the carrying member.

18. The gearbox according to claim 16, wherein the connection structure comprises a flange pad and a bushing body, the flange pad is disposed in the first recess, the bushing body is disposed in the communication hole, the flange pad is clamped between the end cap and a bottom of the first recess, one end of the bushing body abuts against the carrying member, and a reserved gap is formed between another end of the bushing body and the flange pad.

19. The gearbox according to claim 16, wherein the thrust pad further comprises a second recess, the first recess and the second recess communicate with two sides of the communication hole respectively, an area of a bottom of the first recess and an area of a bottom of the second recess are each greater than an opening area of the communication hole, and an opening of the second recess faces the carrying member, and
the connection structure comprises a flange pad and a bushing body, the flange pad is disposed in the first recess, the bushing body is disposed in the communication hole, the flange pad is clamped between the end cap and the bottom of the first recess, and a reserved gap is formed between the bushing body and one of the carrying member or the flange pad.
